(19) United States
(12) Patent Application Publication
(10) Pub. No.: US 2008/0182036 A1
(43) Pub. Date: Jul. 31, 2008

(54) METHODS AND DEVICE FOR MICROSTRUCTURE FABRICATION

(76) Inventor: Norbert Krause, Norman Park (AU)

Correspondence Address: GREENBERG TRAURIG, 3773 HOWARD HUGHES PARKWAY, SUITE 500 NORTH, LAS VEGAS, NV, 89169, US

(21) Appl. No.: 11/857,308

(22) Filed: Sep. 18, 2007

(30) Foreign Application Priority Data
Sep. 18, 2006 (AU) 20066905146

(51) Int. Cl. B05D 3/12; B05D 5/06

(52) U.S. Cl. 427/553; 427/277; 427/240; 427/532; 427/163.2; 425/363

(57) ABSTRACT

A method of forming at least one primary microstructure on a substrate (10) is described. A relief structure (14) is provided for contacting a layer of microstructure forming fluid (12), the relief structure including (i) at least one primary cavity (16) which defines the at least one primary microstructure; (ii) at least one secondary cavity (18) for receiving residual microstructure forming fluid; and (iii) at least one bearing surface (24) for bearing against the substrate, the at least one bearing surface separating the at least one primary cavity and the at least one secondary cavity. A layer of microstructure forming fluid is provided between the relief structure and the substrate and at least one of the substrate and the relief structure is moved relative to the other so that the bearing surface comes to bear against the substrate. The movement displaces a portion of the microstructure forming fluid to occupy the at least one primary cavity, forming the at least one primary microstructure and displaces the residual microstructure forming fluid to be received by, and at least partially occupy, the at least one secondary cavity.

### CROSS-REFERENCE TO RELATED PATENT APPLICATION

This application claims priority under 35 U.S.C. § 119 based on Australian Patent Application No. 2006905146, filed 18 Sep. 2006, which is incorporated by reference herein in its entirety.

### FIELD OF THE INVENTION

The present invention relates generally to processes and devices for the fabrication of micro-sized or smaller structures. More particularly, the present invention relates to processes and devices for the fabrication of micro-sized or smaller structures on a substrate using a mould or similar device.

### BACKGROUND OF THE INVENTION

The fabrication of microstructures and smaller structures, often in a pattern on a substrate, is of significant importance to a wide range of technologies, including electronics, optics, material engineering and mechanics. In a range of applications, small structures offer numerous advantages, including smaller size, greater density, improved portability, faster operation, higher performance, lower power consumption, reduced manufacturing costs and new functionality.

For some time, microstructures, that is structures with features and dimensions on a micrometre scale, have been used to enhance electronic devices, such as processors and electronic memory. More recent advances in small structure fabrication have allowed the production of even smaller structures, such as nanostructures with nanometre fidelity, and have expanded the potential applications for small structures, such as in the production of optical devices.

A known method for fabricating microstructures and smaller structures is soft- lithography. Soft-lithography refers to a number of different fabrication techniques, all of which use an elastomeric material as a stamp, mould or mask. One form of soft-lithography is replica moulding. Replica moulding involves a mould formed from an elastomeric material, such as polydimethylsilozane (PDMS). The mould has cavities or relief features which are shaped to mould the microstructure or smaller structure.

A known process for fabricating a microstructure or smaller structure on a substrate using replica moulding is shown in FIGS. 18 to 20. A layer of fluid 210, such as a suitable polymer, is evenly distributed over the substrate 212. The PDMS mould 214 is pressed into the fluid 210. This causes the fluid 210 to flow into the cavities in the mould 214. The fluid 210 is then set, for instance by exposure to UV radiation, and the mould 214 removed. Removal of the mould 214 is assisted by the elastic deformation of the mould 214.

Replica moulding has many advantages. The process:
(a)replicates a mould and so is adaptable to high volume production;
(b) requires a small number of straightforward steps;
(c) requires minimal initial capital outlay and operating costs;
(d)can be used to produce small structures from a wide range of materials on a wide range of substrate materials;
(e)can be used to produce prototypes in a little as 24 hours; and
(f) unlike techniques such as photo-lithography, can produce structures with a fidelity that is not limited by optical diffraction.

However, a known disadvantage of present replica moulding techniques is the occurrence of a thin layer of excess fluid 216 (sometimes called a ‘scum layer’) between the fabricated microstructures or smaller structures. The scum layer may be as large as tens of microns thick and may interfere with the intended characteristics of the structures.

One approach which overcomes the problem of a scum layer is to remove excess material located between the desired structures after the fluid has been cured. A masking and etching step is typically used to accomplish this. However, the masking and etching step complicates the replica moulding process, increasing costs and the time required to fabricate structures. Additionally, the etching process must be carried out with care so that portions of the desired structures are not inadvertently removed. Such precision is difficult to achieve on the micro and nano scale.

Reference in the specification to any background art is not, and should not be taken as, an acknowledgement or suggestion that the background art forms part of the common general knowledge in Australia, or any other jurisdiction, or that the background art could reasonably be expected to be ascertained, understood and regarded as relevant by a person skilled in the art.

### SUMMARY OF THE INVENTION

According to a first aspect of the invention there is provided a method of forming at least one primary microstructure on a substrate, the method comprising:
(a) providing a relief structure for contacting a layer of microstructure forming fluid, the relief structure including:
   (i) at least one primary cavity which defines the at least one primary microstructure;
   (ii) at least one secondary cavity for receiving residual microstructure forming fluid; and
   (iii) at least one bearing surface for bearing against the substrate, the at least one bearing surface separating the at least one primary cavity and the at least one secondary cavity;
(b) providing a layer of microstructure forming fluid between the relief structure and the substrate; and
(c) moving at least one of the substrate and the relief structure relative to the other so that the bearing surface comes to bear against the substrate, thereby:
   (i) displacing a portion of the microstructure forming fluid to occupy the at least one primary cavity, forming the at least one primary microstructure; and
   (ii) displacing the residual microstructure forming fluid to be received by, and at least partially occupy, the at least one secondary cavity.

According to a further aspect of the invention there is provided a method of forming at least one primary microstructure on a substrate, the method comprising:
(a) providing a relief structure for contacting a layer of microstructure forming fluid, the relief structure having at least one primary cavity which defines the at least one primary microstructure and a substrate bearing surface which defines at least one primary cavity opening, for bearing against a substrate;
(b) providing a substrate having at least one secondary cavity for receiving residual microstructure forming fluid and a structure bearing surface which defines at least one secondary cavity opening, for bearing against the relief structure;
(c) providing a layer of microstructure forming fluid between the relief structure and the substrate; and
(d) moving at least one of the substrate and the relief structure relative to the other so that the substrate bearing surface bears against the structure bearing surface, the bearing surfaces separating the at least one primary cavity from the at least one secondary cavity, thereby:
   (i) displacing a portion of the microstructure forming fluid to occupy the at least one primary cavity, forming the at least one primary microstructure; and
   (ii) displacing the residual microstructure forming fluid to be received by, and at least partially occupy, the at least one secondary cavity.

According to a further aspect of the invention there is provided a mould for forming at least one primary microstructure on a substrate surface from microstructure forming fluid, the mould including:
(a) at least one primary cavity which defines in relief the at least one primary microstructure and which, in use, receives a portion of the microstructure forming fluid to occupy the at least one primary cavity to form the at least one primary microstructure;
(b) at least one secondary cavity that, in use, receives displaced residual microstructure-forming fluid; and
(c) at least one bearing surface for bearing against the substrate, the at least one bearing surface separating the at least one primary cavity and the at least one secondary cavity.

### BRIEF DESCRIPTION OF THE DRAWINGS

The invention is described, by way of example only, with reference to the accompanying drawings in which:

FIG. 1 is a schematic cross sectional view of a first step in the fabrication of a small structure in accordance with a first embodiment of the invention;

FIG. 2 is a schematic cross sectional view of a second step in the fabrication of a small structure in accordance with a first embodiment of the invention;

FIG. 3 is a schematic cross sectional view of a third step in the fabrication of a small structure in accordance with a first embodiment of the invention and includes a schematic cross sectional view of the small structure fabricated;

FIG. 4 is a schematic cross sectional view of a first step in the fabrication of a small structure in accordance with a second embodiment of the invention;

FIG. 5 is a schematic cross sectional view of a second step in the fabrication of a small structure in accordance with a first embodiment of the invention;

FIG. 6 is a schematic cross sectional view of a third step in the fabrication of a small structure in accordance with a second embodiment of the invention and includes a schematic cross sectional view of the small structure fabricated;

FIG. 7 is a schematic cross sectional view of a first step in the fabrication of a small structure in accordance with a third embodiment of the invention;

FIG. 8 is a schematic cross sectional view of a second step in the fabrication of a small structure in accordance with the third embodiment of the invention;

FIG. 9 is a schematic cross sectional view of a first step in the fabrication of a small structure in accordance with a fourth embodiment of the invention;

FIG. 10 is a schematic cross sectional view of a second step in the fabrication of a small structure in accordance with the fourth embodiment of the invention;

FIG. 11 is a schematic cross sectional view of a third step in the fabrication of a small structure in accordance with the fourth embodiment of the invention;

FIG. 12 is a schematic plan view of a mould for a microstructure in accordance with a third embodiment of the invention;

FIG. 13 is a perspective view of a microstructure fabricated in accordance with a third embodiment of the invention;

FIG. 14 is a plan view of a pattern of a microstructure fabricated in accordance with a third embodiment of the invention;

FIG. 15 is a schematic cross sectional view of a master mould which can be used to fabricate a mould in accordance with a first embodiment of the invention;

FIG. 16 is a schematic cross sectional view of the creation of a mould in accordance with a first embodiment of the invention;

FIG. 17 is a schematic cross sectional view of a mould in accordance with a first embodiment of the invention;

FIG. 18 is included for comparative purposes only and shows a schematic cross sectional view of a first step in the fabrication of a small structure using a background art process;

FIG. 19 is included for comparative purposes only and shows a schematic cross sectional view of a second step in the fabrication of a small structure using a background art process; and

FIG. 20 is included for comparative purposes only and shows a schematic cross sectional view of a third step in the fabrication of a small structure using a background art process.

### DETAILED DESCRIPTION OF THE EMBODIMENTS

The following description refers to preferred embodiments of the present invention. To facilitate an understanding of the present invention, reference is made to the accompanying drawings which illustrate preferred embodiments of the present invention. For ease of communication, similar components between the drawings are identified by the same reference numerals.

Throughout this specification, unless otherwise indicated, the term “microstructure”, and grammatical variants, is used to describe a structure with a fidelity on a micrometre scale or smaller, including microstructures and nanostructures.

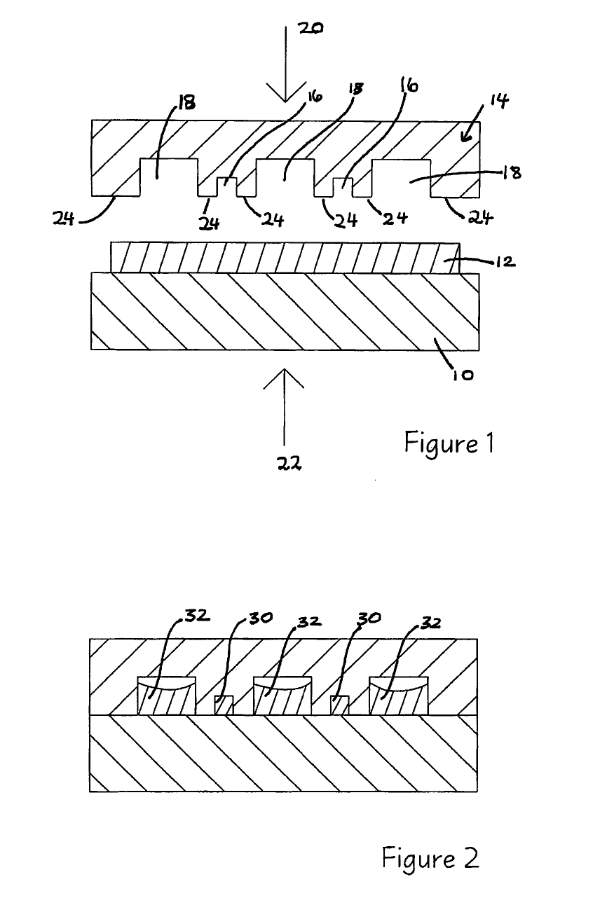

FIGS. 1 to 3 show stages of a process for fabricating of a desired microstructure in accordance with the principles of the present invention. The desired microstructure is fabricated on a substrate 10 from a fluid 12. The substrate may be any material upon which the fluid 12 can be formed. Materials which are suitable as a substrate 10 include semiconductors, silicon, silica, metals, metal alloys, glass, plastics and ceramics. The substrate 10 may have a variety of shapes. An example of a suitable substrate 10 is a planar optical waveguide.

The fluid 12 is shaped during fabrication by a mould 14 to form the desired microstructures. The fluid 12 must be sufficiently viscous to be shaped by the mould 14. It must also be possible to solidify the fluid 12 to fix the fluid 12 in the shape of the desired microstructure. Examples of suitable fluids include polymers, colloidal materials, sol—gel materials, organic and inorganic salts and biological macromolecules. The fluid 12 may be produced from a solid, for instance by heating a solid until it liquefies.

The mould 14 has primary cavities 16 which define, in relief, the shape of the desired microstructure. There may be one primary cavity or more than one primary cavity, depending on the desired microstructure. The shape of the primary cavities 16 depends on the shape of the desired microstructure.

In addition to primary cavities 16, the mould 14 has secondary cavities 18. The secondary cavities 18 receive excess fluid 12 during the fabrication process, thereby preventing the formation of a thin scum layer on the substrate. There may be one secondary cavity or more than one secondary cavity. Between the primary cavities 16 and the secondary cavities 18 are bearing surfaces 24 which bear against the substrate 10 during the fabrication process. The design, operation and function of the secondary cavities are discussed in greater detail below.

The mould 14 may be formed from any suitable material. Preferably, the mould 14 is formed from a material which does not react with the fluid 12 or the substrate 10, can be shaped to have very small features, retains its shape during the fabrication process and has a surface that is low in interfacial free energy. The mould 14 may be formed from a rigid or flexible material. An advantage of a flexible mould 14 is that the mould may be deformed to produce the desired microstructure, to contour to a non-planar substrate and to allow the desired microstructure to be readily released after solidification or curing. A preferred material for the mould 14 is polydimenthylsilozane (“PDMS”).

FIG. 1 shows a stage in the fabrication process. The fluid 12 has been distributed over the region of the substrate 10 where the desired microstructure is to be formed. The fluid 12 may be distributed by spin coating or other suitable method. The volume of the fluid 12 used should be less than the total of the volume of the primary cavities 16 and the secondary cavities 18. This ensures that the secondary cavities 18 are not completely filled before the bearing surfaces 24 bear against the substrate 10. Otherwise, once the cavities 16, 18 are filled, any residual fluid 12 will form a “scum layer”.

The mould 14 and the substrate 10 are then moved together, as indicated by the arrows 20 and 22. Either or both of the substrate 10 and the mould 14 may be moved to accomplish this. A preferred technique is to keep the substrate 10 stationary on a stationary surface and apply a force to the mould 14 so that the mould 14 is forced against the substrate 10.

As the mould 14 moves towards the substrate 10, the mould 14 displaces the fluid 12. The fluid 12 is displaced by the bearing surfaces and the substrate 10 into the primary cavities 16 and the secondary cavities 18, partially filing both types of cavities. As the mould 14 and the substrate 10 move closer together, more fluid 12 fills the primary cavities 16 and the secondary cavities 18. Preferably the mould 14 is air permeable so that air in the cavities 16, 18 can be displaced as the cavities are filled.

Preferably the primary cavities 16 and the secondary cavities 18 are shaped and positioned so that the primary cavities 16 are completely filled with the fluid 12 whilst the secondary cavities 18 are only partially filled with the fluid 12. This may be accomplished by using appropriate shapes for the secondary cavities 18 and appropriate spacing for the secondary cavities 18 to manage the flow of the fluid 12 when the mould 14 and the substrate 10 are pressed together. It is important that the primary cavities 16 are completely filled. Otherwise the desired microstructure will not be correctly formed.

Once the primary cavities 16 are completely filled with fluid 12, the primary cavities 16 do not have any further capacity for residual fluid 12. The portion of the fluid 12 which does not occupy a primary cavity 16 will be referred to as “residual fluid”, since this fluid is ‘left over’ or residual after the primary cavities 16 are completely filled.

Instead of forming a “scum layer”, residual fluid 12 is displaced to occupy the secondary cavities 18. As the mould 14 and the substrate 10 continue to move closer together, the primary cavities 16 remain filled and residual fluid 12 continues to partially fill the secondary cavities 18. Eventually the bearing surfaces 24 will bear against the substrate 10. At this stage substantially all of the fluid 12 has been displaced to completely fill the primary cavities 16 and partially fill the secondary cavities 18. This is shown in FIG. 2.

As can be seen in FIG. 2, the fluid 12 in the partially filled secondary cavities 18 have a concave upper surface. This is due to the cohesion of the fluid 12 and the adhesion of the fluid 12 to the mould 14. Different fluids and mould materials result in different degrees of cohesion and adhesion. Certain fluids and mould materials will result in the fluid 12 in the partially filled secondary cavities 18 having a concave upper surface.

Once the bearing surfaces 24 of the mould 14 bear against the substrate 10, as shown in FIG. 2, the fluid 12 is solidified. The appropriate solidification process depends on the type of fluid 12 used. Often the fluid 12 is cured by inducing chemical reactions through exposure to radiation, for instance UV light. For example, if a UV reactive polymer fluid is used, the polymer fluid is cured by exposure to UV light. Alternatively a fluid which undergoes chemical reactions over time may be used, in which case the fluid solidifies after the appropriate time has elapsed. An example of this type of fluid is an epoxy which sets a certain time after being mixed. A further alternative is to control the temperature of the fluid, either by heating or cooling, to either induce chemical changes in the fluid or cause the fluid material to enter a solid state. For example, the fluid may be cooled until it solidifies or may be cured by baking.

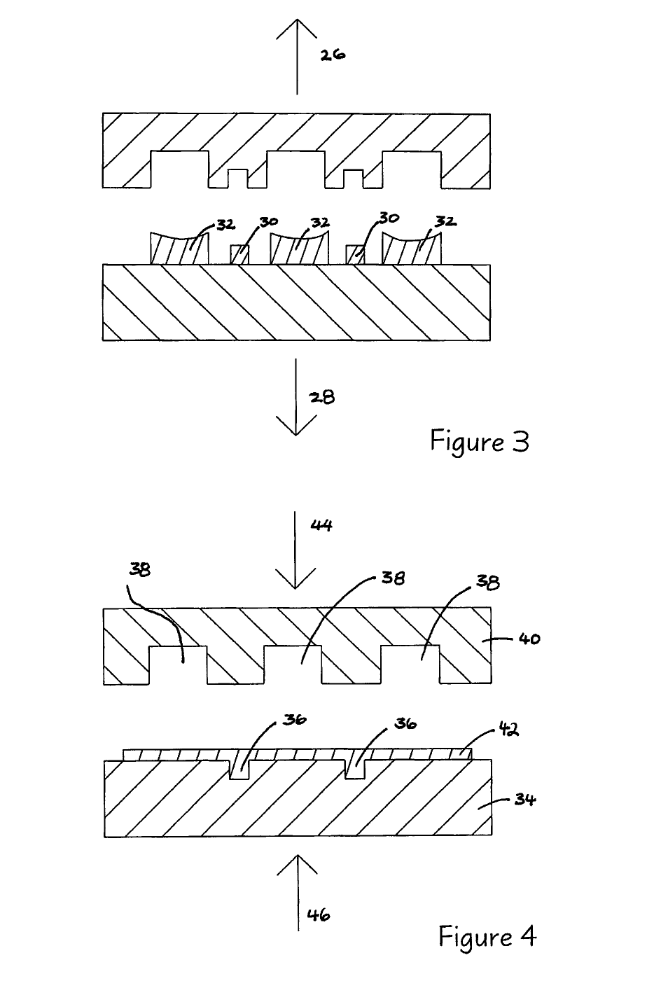

After the fluid 12 solidifies, the mould 14 is removed. The mould 14 and the substrate 10 are moved apart, as indicated by arrows 26 and 28 in FIG. 3. In the case of a flexible mould, the mould can be flexed to assist removal. The solidified fluid 12 adheres to the substrate. Fluid 12 which completely filled the primary cavities 16, forms the desired microstructures 30. Fluid 12 which filled the secondary cavities 18, forms secondary microstructures 32. The secondary microstructures 32 are separate from the desired microstructures 30. The secondary microstructures 32 do not interfere with or alter the desired functionality of the desired microstructures. Between the microstructures 30, 32 there is no measurable “scum layer”.

Though the secondary microstructures 32 are separate to the desired microstructures 30 and do not affect the functionality of the desired microstructures 30, the secondary microstructures 32 may be shaped and positioned to serve ancillary purposes. For instance, the secondary microstructures 32 may protrude further from the substrate 10 than the desired microstructures 30 and be positioned around the desired microstructures 30. This arrangement provides the desired microstructures 30 with some protection during handling and use. Objects tend to collide with the protruding secondary microstructures 32 rather than the desired microstructures 30.

After the mould 14 has been removed as shown in FIG. 3, the secondary microstructures 32 may optionally be removed. A variety of known techniques can be used to accomplish this. For instance, the secondary microstructures 32 may be removed using an etching or masking and etching technique.

As stated previously, the total volume of the primary cavities 16 and the secondary cavities 18 must be equal to or greater than the total volume of fluid 12 used. This condition is preferably satisfied in local regions of the mould 14, in addition to for the entire mould 14. Many different secondary cavity 18 shapes, spacings and configurations will satisfy this condition for any desired microstructure 16. For a desired microstructure, suitable shapes, spacing and configurations should be selected for the secondary cavities 18.

The secondary cavities 18 are advantageously shaped and spaced to:
(a) ensure there is a sufficient volume of secondary cavities 18 in each local region of the mould to accept any residual fluid in the local region;
(b) appropriately manage capillary forces associated with the fluid 12;
(c) appropriately manage the surface wetting properties of the mould 14;
(d) facilitate easy removal of the mould (for instance, simple geometric shapes generally allow easy removal of the mould); and
(e) ensure that the mould does not undesirably deform or collapse during the fabrication process.

Optionally, the secondary cavities 18 may have a volume which is greater than the volume of the primary cavities 16, in either or both of a local region and the whole mould 14. In certain cases, this promotes complete filling of primary cavities 16 before the bearing surface 24 bears against the substrate 10.

If the secondary cavities 18 are deeper than the primary cavities 16, then the primary cavities 16 will tend to completely fill with fluid 12 before the secondary cavities 18. It is consequently an advantage if the maximum depth of the secondary cavities 18 is greater than the maximum depth of the primary cavities 16, both in local regions and for the entire mould, though this is not strictly necessary.

The secondary cavities 18 should be set back from the primary cavities 16 to ensure that the desired functionality of the desired microstructure to be fabricated is not compromised. For instance, if the fabrication process is used to produce an optical waveguide, the secondary cavities 18 should be set back from the primary cavities 16 by a sufficient distance to minimise optical coupling between the primary cavities 16 and the secondary cavities 18. If necessary, the optical effect of the secondary cavities 18 can be further minimised by irregularly spacing the secondary cavities 18 to prevent cumulative periodic effects.

It has been found that one effective configuration is to evenly distribute secondary cavities 18 over the mould 14 around the primary cavities 16. The secondary cavities 18 are preferably spaced sufficiently closely so that residual fluid flows into the secondary cavities 18 without requiring significant pressure to urge the mould 14 and substrate 10 together. At the same time, secondary cavities 18 are preferably spaced sufficiently far apart so that the mould 14 does not deform during fabrication.

FIGS. 4 to 6 show an alternate method for implementing the invention. The mould 34 has primary cavities 36 which are shaped to define a desired microstructure in relief. Secondary cavities 38 are provided and function in a similar way to those described in FIGS. 1 to 3 However, the secondary cavities 38 are located in the substrate 40, rather than the mould 34.

A layer of fluid 42 is distributed over the mould 34, for instance by spin coating. The substrate 40 and the mould 34 are then moved together as indicated by arrows 44 and 46. The mould 34 and the substrate 40 must be correctly aligned so that primary cavities 36 do not align with the secondary cavities 38. This ensures that the secondary cavities 38 are not connected to the primary cavities 36 when the mould 34 bears against the substrate 40.

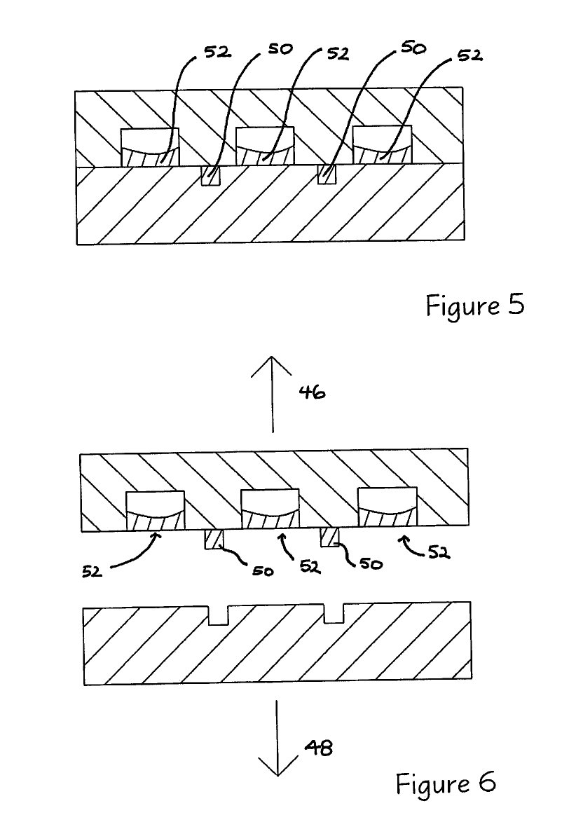

As the mould 34 and the substrate 40 move towards each other, the substrate 40 displaces the fluid 42 on the mould 34. This causes the fluid 42 to flow into the secondary cavities 38. This continues to occur until the mould 34 bears against the substrate 40. This is shown in FIG. 5. At this stage, the primary cavities 36 are completely filled with fluid 42 and the secondary cavities 38 are partially filled with fluid 42. It is important that the sum of the volume of the secondary cavities 38 and the primary cavities 36 in a local area and for the area of the mould 34, is greater than the volume of fluid 42 used. This ensures that a “scum layer” does not occur.

Using this method, it is not critical that the secondary cavities 38 be of greater volume than the primary cavities 36 or that the secondary cavities 38 be deeper than the primary cavities 36. This is because the primary cavities 36 are filled with fluid 42 when the fluid is distributed on the mould 34. Consequently there is no need to manage the fluid flow such that the primary cavities 36 are completely filled before the secondary cavities 38.

The fluid 42 is then solidified as is described above in relation to FIGS. 1 to 3. This forms the desired microstructures 50 and secondary microstructures 52, as shown in FIG. 5.

The mould 34 is then removed from the substrate 40, as indicated by arrows 46 and 48 in FIG. 6. Since the adhesion of the fluid 42 to the substrate 40 is greater than the adhesion of the fluid 42 to the mould 34, the secondary microstructures 52 remain with the substrate 40 and are held in place by adherence to the walls of the secondary cavities 38. The secondary microstructures 52 may be removed using known techniques, such as etching, if necessary.

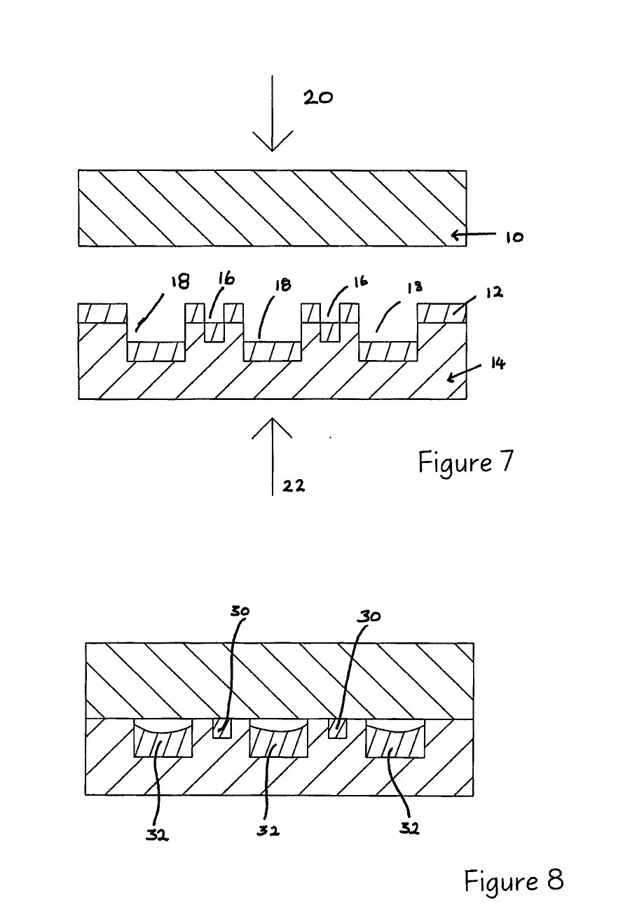

FIGS. 7 and 8 show a variation to the fabrication process described above with reference to FIGS. 1 to 3. The mould 14 and substrate 10 are as described with reference to FIGS. 1 to 3. Instead of applying the fluid 12 to the substrate 10, the fluid is applied to the mould 14. Any suitable fluid application process, such as spin coating or spraying, may be used.

The mould 14 and the substrate 10 are then moved together as indicted by arrows 20 and 22. The movement causes fluid 12 to completely fill the primary cavities 16. Any residual fluid 12 is displaced to partially fill the secondary cavities 18. The fluid 12 is then solidified and the mould 14 is removed from the substrate 10.

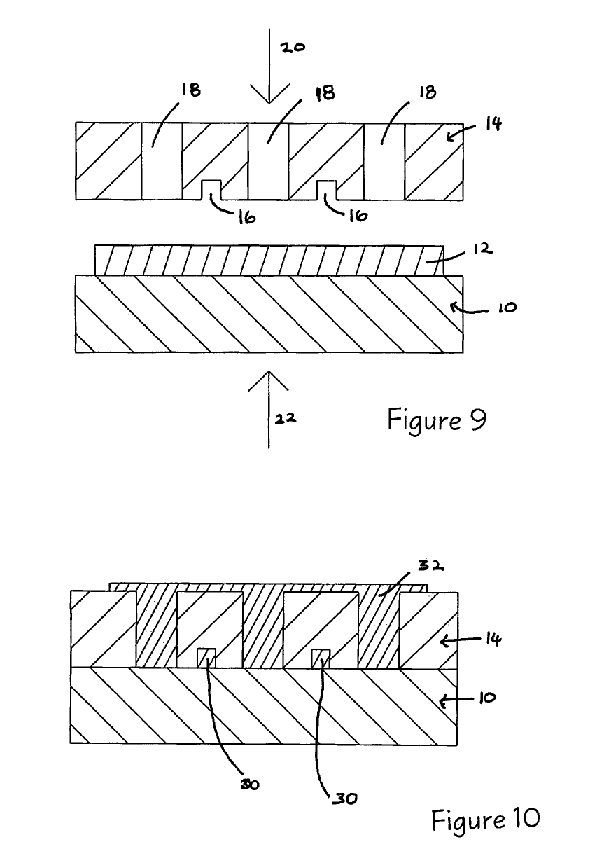

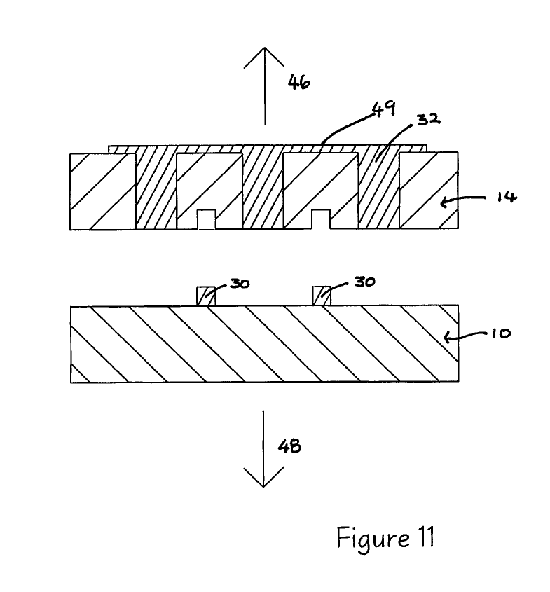

FIGS. 9 to 11 show a further variation to the fabrication process. The secondary cavities 18 have more than one opening and form conduits from the bearing surface of the mould to the opposite surface. Fluid 12 is applied to the substrate 10. The substrate 10 and the mould 14 are then moved together, as indicated by arrows 20 and 22. Fluid 12 is displaced to fill the primary cavities 16. Instead of residual fluid partially filling secondary cavities 18, the residual fluid flows through the secondary cavities 18 and pools on the non-bearing surface. The fluid may optionally be removed from the surface. A negative relative pressure may be applied to the conduits to assist flow of residual fluid through the conduits. When using conduits, the volume of the conduits is not as important, as fluid can flow through the conduits.

FIG. 10 shows the mould 14 after it has been moved into contact with the substrate 10. Residual fluid has been left to pool on the rear of the mould. The fluid 12 is then solidified using an appropriate method. The pool of fluid 12 when solidified forms an upper surface 49 of the secondary microstructure 32. Once solidification is complete, the mould 14 is removed from the substrate 10, as is indicated by arrows 46 and 48. Removal of the mould 14 acts on the upper surface 49 of the secondary microstructure 32, causing the secondary microstructure 32 to be removed from the substrate 10 in a single step.

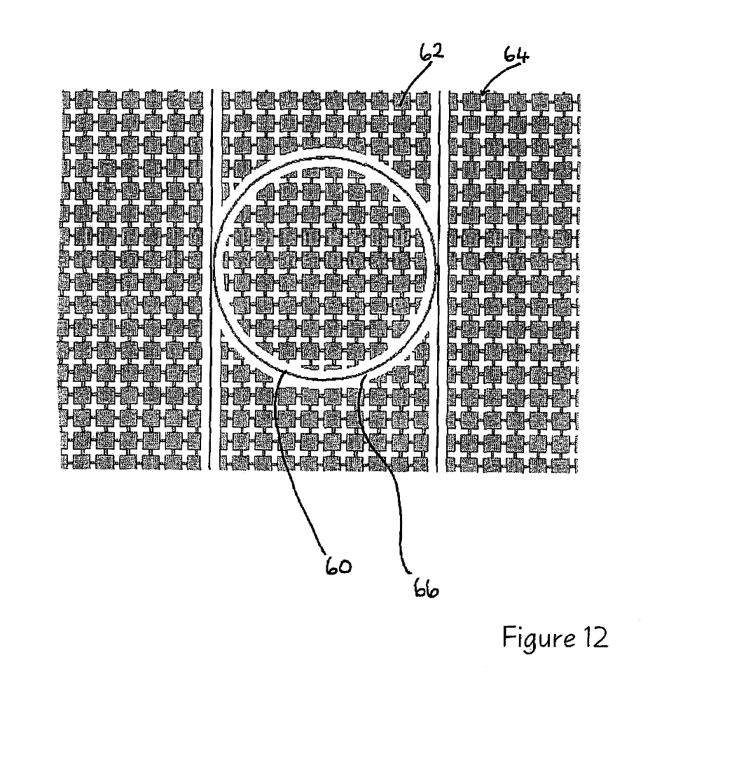

FIGS. 12 to 14 show a further example of a mould in accordance with the invention. FIG. 7 shows a schematic plan for the mould. The mould has a primary cavity 60 which is shaped to fabricate a micro-ring resonator on an optical substrate. Surrounding the primary cavity 60 is a matrix of secondary cavities 62. Each of the secondary cavities 62 is linked to its adjacent secondary cavities by a link 64. The links allow fluid to flow between the secondary cavities 62 and pressure in a secondary cavity 62 to be distributed amongst other secondary cavities 62. There is a gap 66 between the primary cavity 60 and the secondary cavities 62 which prevents secondary microstructures formed in the secondary cavities 62 interfering with the desired function of the micro-ring resonator formed by the primary cavities 60.

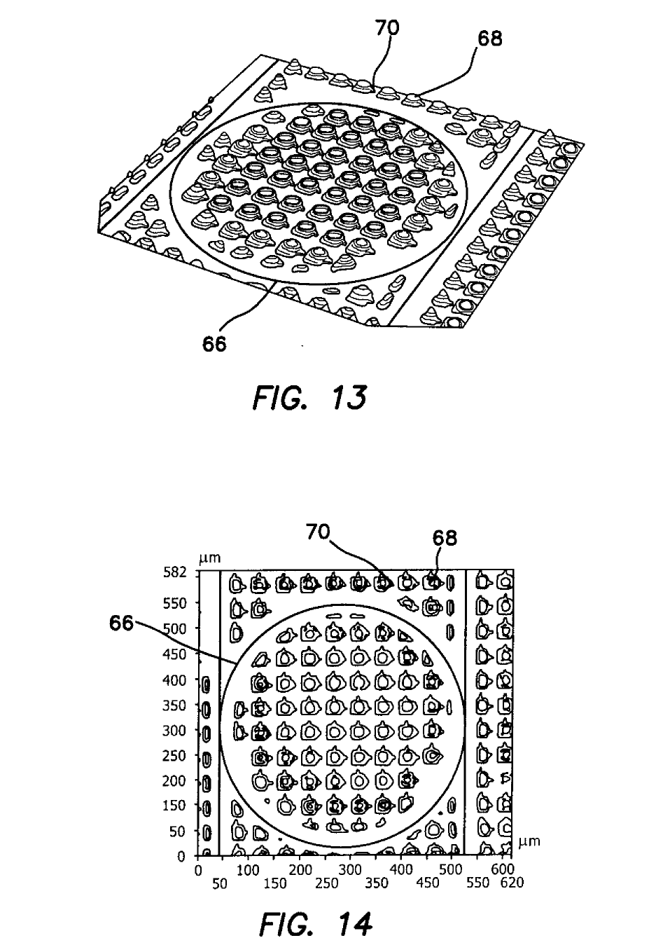

FIGS. 13 and 14 show a desired microstructure 66 and secondary microstructures 68 fabricated using the mould depicted in FIG. 12. As can be seen, there is no “scum layer” between the microstructures 66, 68. The secondary microstructures 68 have a “crater-like” shape because the secondary cavities 62 were partially filled by a fluid subject to cohesive and adhesive effects. Secondary microstructures 68 which are closer to the primary microstructure 66 are larger in size. Since the primary cavities 60 of the mould have a smaller volume, there is more residual fluid in the areas local to the primary cavities 60. Consequently, more residual fluid is locally displaced into the secondary cavities 62, forming larger secondary microstructures 68.

The links 70 between the secondary microstructures 68 provide an additional advantage, if the secondary microstructures are to be removed. Secondary microstructures 68 that are linked together may be more easily removed as one piece.

The mould used to fabricate the desired microstructures may be itself fabricated using a variety of techniques, including photolithography and soft lithography. To avoid a “scum layer” the mould may be fabricated using the method described in this specification.

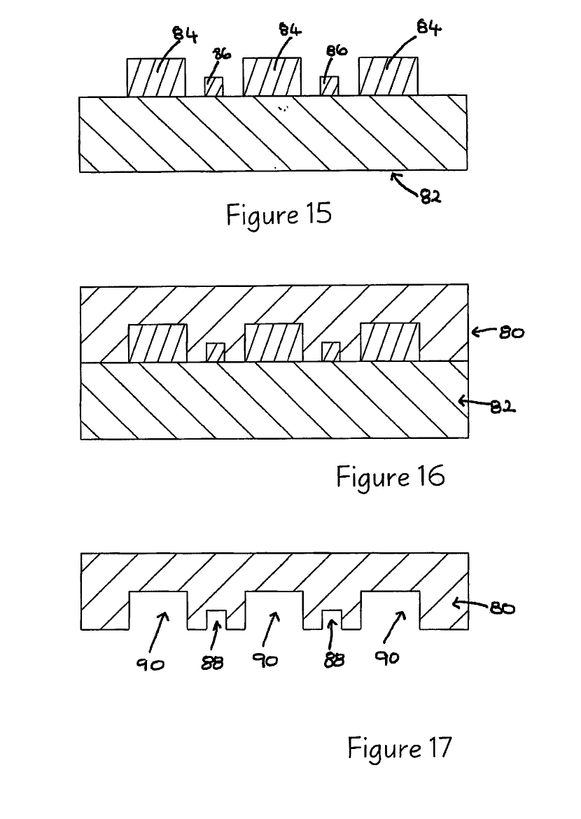

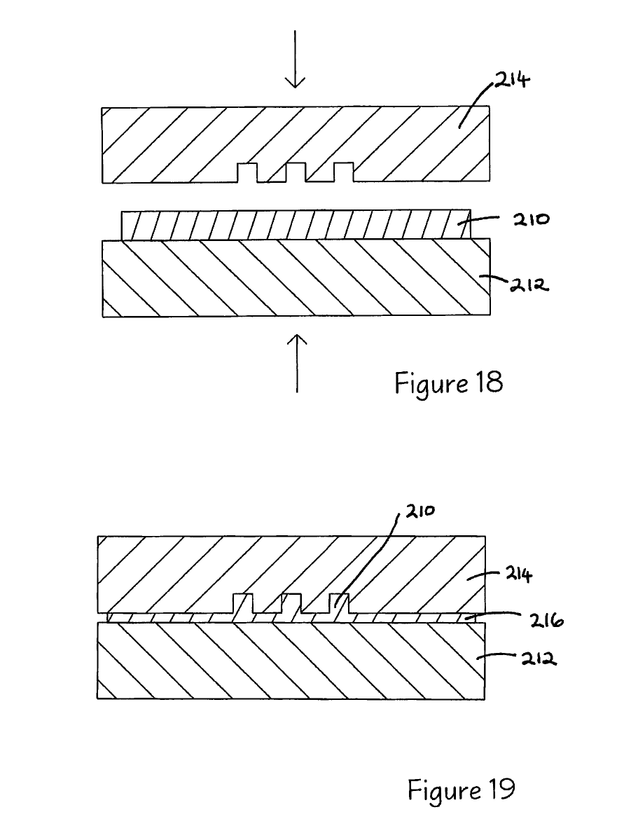

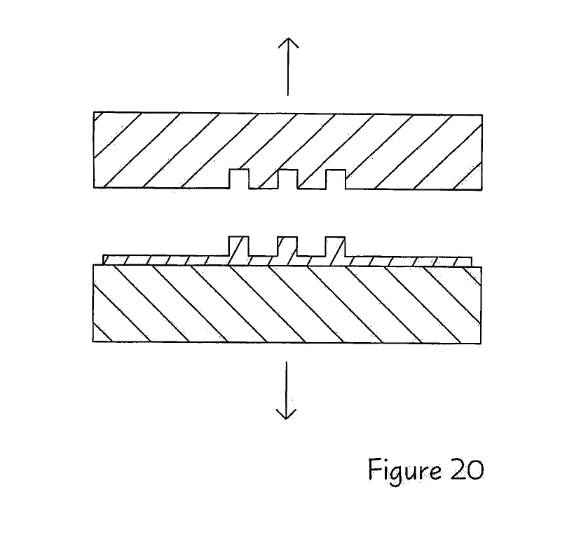

Preferably the mould is fabricated from a master mould. FIGS. 15 to 17 show a process for fabricating a mould 80 from a master mould 82 using PDMS. Firstly, a master mould 82 must be produced. This can be done using known techniques including photolithography and soft lithography. FIG. 10 shows an example of a master mould 82.

PDMS is then distributed over the master mould 82. The PDMS is cured using an appropriate technique and removed. Primary features 84 of the master mould 82 form primary cavities 88. Secondary features 86 of the master mould 82 form secondary cavities 90. FIG. 12 shows the mould 80 produced.

There are many different methods for fabricating microstructures using a mould, stamp or similar relief structure to displace a fluid. These methods may be modified by the use of secondary cavities as described in this specification and the secondary cavities will reduce or eliminate the formation of a “scum layer”. The above embodiments of the present invention are merely examples of the invention and other manners in which the various features can be arranged so as to allow the operation of the present invention are understood to fall within the spirit and scope of the present invention as claimed and described.

The invention disclosed and defined in this specification extends to all alternative combinations of two or more of the individual features mentioned or evident from the text or drawings. All of these different combinations constitute various alternative aspects of the invention.

The term “comprises” (or its grammatical variants) are used in this specification as the equivalent of the term “includes” and should not be taken as excluding the presence of other elements or features.

I claim:

1. A method of forming at least one primary microstructure on a substrate, the method comprising:
(a) providing a relief structure for contacting a layer of microstructure forming fluid, the relief structure including:
(i) at least one primary cavity which defines the at least one primary microstructure;
(ii) at least one secondary cavity for receiving residual microstructure forming fluid; and
(iii) at least one bearing surface for bearing against the substrate, the at least one bearing surface separating the at least one primary cavity and the at least one secondary cavity;
(b) providing a layer of microstructure forming fluid between the relief structure and the substrate; and
(c) moving at least one of the substrate and the relief structure relative to the other so that the bearing surface comes to bear against the substrate, thereby:
(i) displacing a portion of the microstructure forming fluid to occupy the at least one primary cavity, forming the at least one primary microstructure; and
(ii) displacing the residual microstructure forming fluid to be received by, and at least partially occupy, the at least one secondary cavity.

2. A method as claimed in claim 1, in which the residual microstructure forming fluid is displaced and received by the secondary cavity, thereby forming at least one secondary microstructure which is separate from and in addition to the at least one primary microstructure.

3. A method as claimed in claim 1, in which the at least one secondary cavity has only a single cavity opening defined by the bearing surface.

4. A method as claimed in claim 1, in which the total volume of the at least one secondary cavity in a local region of the relief structure is greater than the total volume of the layer of micro-structure forming fluid compressed in the local region less the total volume of the at least one primary cavity in the local region.

5. A method as claimed in claim 1, in which the at least one secondary cavity has a total volume which is greater than the total volume of the layer of microstructure forming fluid less the total volume of the at least one primary cavity.

6. A method as claimed in claim 1, in which a secondary cavity depth of the at least one secondary cavity in a local region is greater than a primary cavity depth of an adjacent primary cavity in the local region.

7. A method as claimed in claim 1, in which a secondary cavity depth of each of the secondary cavities is greater than a primary cavity depth of each of the primary cavities.

8. A method as claimed in claim 1, in which the relief structure has a plurality of secondary cavities spaced over the bearing surface and around the at least one primary cavity.

9. A method as claimed in claim 8, in which the plurality of secondary cavities are substantially evenly spaced over the bearing surface and around the at least one primary cavity.

10. A method as claimed in claim 8, in which the plurality of secondary cavities are substantially irregularly spaced over the bearing surface and around the at least one primary cavity.

11. A method as claimed in claim 1, in which the relief structure is a mould.

12. A method as claimed in claim 1, in which the relief structure is formed from an elastomeric material.

13. A method as claimed in claim 12, in which the relief structure is formed from a polydimethylsiloxane elastomer.

14. A method as claimed in claim 12, in which the at least one secondary cavity is positioned and shaped to minimise flexing of the relief structure during displacement of the microstructure forming fluid.

15. A method as claimed in claim 1, in which the relief structure is formed from an air permeable material.

16. A method as claimed in claim 1, further comprising distributing a microstructure forming fluid over at least one of a region of the substrate and a region of the relief structure to form the layer of microstructure forming fluid.

17. A method as claimed in claim 16, in which the microstructure forming fluid is distributed over the region by spin coating.

18. A method as claimed in claim 1, further comprising solidifying the microstructure forming fluid once the microstructure forming fluid has formed the at least one primary microstructure.

19. A method as claimed in claim 18, in which the microstructure forming fluid is solidified by any one of a chemical change, irradiation and heat.

20. A method as claimed in claim 18, in which the microstructure forming fluid is solidified by exposure to UV light.

21. A method as claimed in claim 18, in which the microstructure forming fluid is solidified by changing the temperature of the fluid.

22. A method as claimed in claim 2, further comprising removing the at least one secondary microstructure from the substrate.

23. A method as claimed in claim 22, in which the secondary microstructure formed is shaped such that separating the mould from the substrate causes the at least one secondary microstructure to be removed from the substrate.

24. A method as claimed in claim 1, in which the at least one secondary cavity forms a conduit from a fluid contacting surface of the relief structure to a non-fluid contacting surface of the relief structure for conducting residual microstructure forming fluid from the fluid contracting surface to the non-fluid contacting surface.

25. A method as claimed in claim 1, in which the substrate is an optical waveguide.

26. A method as claimed in claim 2, in which the at least one secondary microstructure protrudes from the substrate further than the at least one primary microstructure and is located substantially around the at least one primary microstructure.

27. A method as claimed in claim 2, in which the at least one secondary microstructure does not substantially alter the functionality of the at least one primary microstructure.

28. A method as claimed in claim 2, in which the at least one secondary microstructure does not substantially alter the optical properties of the at least one primary microstructure.

29. A method of forming at least one primary microstructure on a substrate, the method comprising:
(a) providing a relief structure for contacting a layer of microstructure forming fluid, the relief structure having at least one primary cavity which defines the at least one primary microstructure and a substrate bearing surface which defines at least one primary cavity opening, for bearing against a substrate;
(b) providing a substrate having at least one secondary cavity for receiving residual microstructure forming fluid and a structure bearing surface which defines at least one secondary cavity opening, for bearing against the relief structure;
(c) providing a layer of microstructure forming fluid between the relief structure and the substrate; and
(d) moving at least one of the substrate and the relief structure relative to the other so that the substrate bearing surface bears against the structure bearing surface, the bearing surfaces separating the at least one primary cavity from the at least one secondary cavity, thereby:
(i) displacing a portion of the microstructure forming fluid to fully occupy the at least one primary cavity, forming the at least one primary microstructure; and
(ii) displacing the residual microstructure forming fluid to be received by, and at least partially occupy, the at least one secondary cavity.

30. A mould for forming at least one primary microstructure on a substrate surface from microstructure forming fluid, the mould including:
(a) at least one primary cavity which defines in relief the at least one primary microstructure and which, in use, receives a portion of the microstructure forming fluid to occupy the at least one primary cavity to form the at least one primary microstructure;
(b) at least one secondary cavity that, in use, receives displaced residual microstructure-forming fluid; and
(c) at least one bearing surface for bearing against the substrate, the at least one bearing surface separating the at least one primary cavity and the at least one secondary cavity.

31. A mould as claimed in claim 30, in which the at least one secondary cavity has a total volume which is greater than the total volume of the at least one primary cavity.

32. A mould as claimed in claim 30, in which a cavity depth of each of the secondary cavities is greater than a cavity depth of each of the primary cavities.

33. A mould as claimed in claim 30, in which the mould has a fluid contact surface for contacting the microstructure forming fluid and a plurality of secondary cavities spaced over the fluid contact surface and around the at least one primary cavity.

34. A mould as claimed in claim 30, in which the at least one secondary cavity forms a conduit from a fluid contacting surface of the mould to a non-fluid contacting surface of the mould for conducting residual microstructure forming fluid from the fluid contracting surface to the non-fluid contacting surface.

35. A mould as claimed in claim 30, in which the mould is formed from an elastomeric material.

36. A mould as claimed in claim 30, in which the mould is formed from an air permeable material.

37. A relief structure for use in the method of claim 1.
